(19) United States
(12) Patent Application Publication
(10) Pub. No.: US 2019/0357558 A1
(43) Pub. Date: Nov. 28, 2019

(54) BLENDS OF ESTERIFIED PROPOXYLATED GLYCEROL AND HIGHER MELTING TRIGLYCERIDES

(71) Applicant: Epogee LLC, Indianapolis, IN (US)

(72) Inventors: Jeffrey R. DiMaio, Pendleton, SC (US); Peter Gennaro, Pendleton, SC (US); Zach Hunt, Simpsonville, SC (US)

(73) Assignee: Epogee LLC, Indianapolis, IN (US)

(21) Appl. No.: 16/381,473

(22) Filed: Apr. 11, 2019

Related U.S. Application Data
(60) Provisional application No. 62/674,886, filed on May 22, 2018.

(51) Int. Cl. A23D 7/00; A23L 29/00

(52) U.S. Cl. CPC A23D 7/003; A23L 29/04; A23V 2200/232; A23V 2250/1946; A23V 2250/1944; A23V 2002/00

(57) ABSTRACT

Certain characteristics of esterified propoxylated glycerol compositions and reduced-fat food products prepared therefrom may be modified and improved by combining such esterified propoxylated glycerol compositions with particular triglyceride compositions having higher melting points, wherein the melting and crystallization properties of each component are taken into account when selecting them for combination. For instance, EPG-based confectionary products having reduced issues with slump, blocking and demolding may be prepared by incorporating such a higher melting triglyceride composition, without compromising the organoleptic qualities of the resulting confectionary.

### CROSS-REFERENCE TO RELATED APPLICATION

This application claims priority to U.S. Provisional Application No. 62/674,886, filed May 22, 2018, the entire disclosure of which is incorporated herein by reference in its entirety for all purposes.

### GOVERNMENT FUNDING STATEMENT

This invention was made with government support under Grant No. IIP-1555998 awarded by the National Science Foundation. The government has certain rights in the invention.

### FIELD OF THE INVENTION

This invention relates to improved fat substitute compositions based on esterified propoxylated glycerol in combination with certain types of triglycerides having melting and crystallization characteristics that are tailored based on particular attributes of the esterified propoxylated glycerol component.

### BACKGROUND OF THE RELATED ART

Esterified propoxylated glycerol (sometimes also referred to as esterified propoxylated glycerin or “EPG”) has long been recognized as a substance potentially useful as a reduced calorie substitute for conventional triglyceride fats and oils in food compositions. Although it is generally resistant to digestion, EPG otherwise has properties and attributes much like those of conventional triglyceride fats and oils and thus can effectively serve as a functional fat in food products. By controlling parameters such as the degree of propoxylation, the level of unsaturation and the type(s) of fatty acid acyl groups present, it is possible to tailor certain characteristics of an EPG composition such as melting point and solid fat content to make it more suitable for particular desired end-use applications. Workers in the field have also recognized, however, that the ingestion of non-digestible fat substitutes which are fully liquid at human body temperature results in an undesirable side-effect of pooling and leaking from the anal sphincter (sometimes referred as “anal leakage”). For this reason, EPG compositions having a melting point at or above human body temperature have been developed which are capable of being consumed in substantial quantities without resulting in such gastrointestinal issues. However, the use of such high melting EPG compositions at high replacement levels creates other problems, such as “waxy mouthfeel” or food products that are too hard. This problem has been addressed by combining such high melting EPG compositions with certain types of vegetable fats that are hard, solid or semi-solid at room temperature (e.g., cocoa butter, palm kernel oil, palm kernel stearin, coconut oil and babassu oil) to provide eutectic blends having melting points below 37° C. See U.S. Pat. Nos. 8,715,764 and 9,011,961. The eutectic blends exemplified in these patent documents in each case utilized a vegetable fat having a melting point lower than that of the EPG with which it was combined.

Obtaining EPG compositions which are able to substantially replace digestible fats and oils in food products without significantly altering the desirable properties of those food products remains challenging. For example, EPG compositions which mimic the relatively high melting point and sharp solid fat content curve of cocoa butter and fractionated palm kernel oil (sometimes referred to as “confectionary EPGs”) have been developed. See, for example, U.S. Pat. No. 5,387,429. When such confectionary EPGs are used to at least partially replace cocoa butter and fractionated palm kernel oil in chocolate and other such confectionary products, however, the results obtained have not been entirely satisfactory. A molded chocolate product prepared using a confectionary EPG may be, for example, difficult to demold and may exhibit excessive slump and/or blocking.

EPG compositions are also known which, while still having a melt point somewhat above human body temperature in order to avoid the above-mentioned gastrointestinal problems, have a “flatter” solid fat content curve as compared to confectionary EPGs. That is, at around room temperature (20-25° C.), the solid fat content of such EPGs is significantly less than that of confectionary EPGs, making food products such as nut butters containing high levels of such EPGs much softer and easier to spread. Typically, such “spreadable” EPGs are formulated with at least some amount of a conventional vegetable oil such as peanut oil. See U.S. Patent Publication No. 2017/0339992. Under certain conditions, the resulting food product may exhibit some degree of phase separation, apparently due to incompatibility between the spreadable EPG and the vegetable oil. It would therefore be desirable to develop methods whereby the fat-like components of such food products may be better compatibilized.

To further elaborate, it has now been discovered that previously known blends of EPGs with certain triglycerides can result in certain characteristic problems:
Rapid solidification: EPGs typically exhibit a relatively low degree of undercool resulting in a faster onset of crystallization, as compared for example to fractionated palm kernel oil (FPKO), resulting in coating issues involving the enrobing, panning and molding of compound chocolate.
Demolding: A liquid fraction present in such blends or possibly simultaneous nucleation of both an EPG-rich crystal phase and a triglyceride-rich crystal phase appears to prevent surface stress release and/or shrinkage of a molded product, creating a greater surface area for adhesion to a mold surface and leading to a tendency for the molded product to stick to a mold.
Blocking: The liquid fraction apparently solubilizes and softens products made from the blends, allowing for increased adhesion at a blend-blend interface. The finished products consequently tend to stick together more than would be desirable.
Oiling out: The liquid fraction may also migrate to the surface of a food product containing the blend as a separate phase, changing the composition and behavior of the bulk blend. Moreover, the separate phase is physically unsightly.
Cold flow/slump: The liquid fraction is believed to increase the void space between crystals and solubilizes interfaces, enabling cold flow of the formulated food product (e.g., a molded chocolate). The formulated food product consequently deforms over time at ambient (room) temperature.

### SUMMARY OF THE INVENTION

It has now been discovered that the blending of certain higher melting triglyceride compositions with esterified propoxylated glycerol compositions can help overcome certain of the aforementioned formulation issues previously associated with EPGs, if the higher melting triglycerides are carefully selected to take into account the characteristics of the EPG being modified. In particular, the higher melting triglyceride composition is selected to have a melt point temperature which is greater than the melt point temperature X of the esterified propoxylated glycerol composition, with crystallization of the higher melting triglyceride composition taking place within a temperature range that overlaps to at least some extent with the temperature range within which crystallization of the esterified propoxylated glycerol composition takes place. The blending of such components permits certain advantages and benefits to be achieved as compared to the use of the esterified propoxylated composition without such higher melting triglyceride composition.

In particular, it is believed that the presence of such a higher melting triglyceride composition may act to compatibilize any liquid phase or fraction that may otherwise be present into the bulk of a solid EPG composition to create a more robust system, thereby overcoming or at least alleviating the above-mentioned issues associated with a two-phase blend.

For example, where the EPG composition is an EPG having a sharp melting point curve resembling that of cocoa butter and it is desired to use the EPG composition in a confectionary product such as a chocolate to replace cocoa butter, using such a higher melting triglyceride to modify the EPG composition provides a blend having a uniform and coherent solid structure at ambient temperatures that reduces or eliminates slump, blocking and/or demolding difficulties, while at the same time maintaining a satisfactory mouthfeel in the formulated confectionary product.

As another example, where the EPG composition is to be combined with a triglyceride having a melting point lower than that of the EPG composition (e.g., a triglyceride which is a liquid oil at room temperature), combining a higher melting triglyceride having the particular characteristics as described herein assists in reducing or avoiding the fractionation of the lower melting triglyceride from the EPG composition wherein at least a portion of the lower melting triglyceride may separate as an oil phase from the EPG composition (especially where the EPG composition has a melting point at or above human body temperature). In this context, the higher melting triglyceride may be considered to be functioning as a compatibilizer between the EPG composition and the lower melting triglyceride. Further, modifying a semi-solid EPG composition with a higher melting triglyceride composition may help to reduce the yield strength of the EPG composition, thereby allowing for a higher level of EPG to be incorporated into the formulated product than would be feasible in the absence of the higher melting triglyceride composition. This permits the caloric content of the formulated product to be desirably lowered.

Without wishing to be bound by theory, it is believed that the above-described beneficial effects of the higher melting triglyceride composition are at least in part attributable to a preferential crystallization of the higher melting triglyceride composition and the EPG composition, thus preventing lower melting triglyceride species from fractionating. Further, the higher melting triglyceride composition may form a eutectic mixture with the EPG composition, resulting in a blend having a melt point temperature below both the melt point temperature of the higher melting triglyceride composition and the melt point temperature of the EPG composition; this serves to reduce the amount of “waxiness” that may otherwise be perceived by a consumer upon ingestion of a food product containing an EPG composition having a melting point greater than human body temperature.

Certain non-limiting, illustrative embodiments of the invention may be summarized as follows:

Aspect 1: A blend comprised of an esterified propoxylated glycerol composition having a melt point temperature X and a higher melting triglyceride composition having a melt point temperature Y which is greater than the melt point temperature X of the esterified propoxylated glycerol composition, wherein i) crystallization of the esterified propoxylated glycerol composition, in the absence of the higher melting triglyceride composition, takes place within a temperature range A, ii) crystallization of the higher melting triglyceride composition, in the absence of the esterified propoxylated glycerol composition, takes place within a temperature range B, and iii) temperature range A and temperature range B at least partially overlap.

Aspect 2: The blend of Aspect 1, wherein the blend has a melt point temperature W that is lower than melt point temperature X.

Aspect 3: The blend of Aspect 1 or 2, wherein melt point temperature Y is not more than 12° C. greater than melt point temperature X.

Aspect 4: The blend of any of Aspects 1-3, wherein melt point temperature Y is not more than 10° C. greater than melt point temperature X.

Aspect 5: The blend of any of Aspects 1-4, wherein the esterified propoxylated glycerol composition has an onset of crystallization temperature I, the higher melting triglyceride composition has an onset of crystallization temperature II, and the onset of crystallization temperature II is from 2° C. above to 10° C. below the onset of crystallization temperature I.

Aspect 6: The blend of any of Aspects 1-5, wherein the esterified propoxylated glycerol composition has an onset of crystallization temperature I, the higher melting triglyceride composition has an onset of crystallization temperature II, and the onset of crystallization temperature II is 0 to 5° C. below the onset of crystallization temperature I.

Aspect 7: The blend of any of Aspects 1-6, comprising more esterified propoxylated glycerol composition by weight than higher melting triglyceride composition.

Aspect 8: The blend of any of Aspects 1-7, comprising 55 to 95 percent by weight of the esterified propoxylated glycerol composition and 5 to 45 percent by weight of the higher melting triglyceride composition based on the total weight of the esterified propoxylated glycerol composition and the higher melting triglyceride composition.

Aspect 9: The blend of any of Aspects 1-8, comprising 65 to 85 percent by weight of the esterified propoxylated glycerol composition and 15 to 35 percent by weight of the higher melting triglyceride composition based on the total weight of the esterified propoxylated glycerol composition and the higher melting triglyceride composition.

Aspect 10: The blend of any of Aspects 1-9, wherein the higher melting triglyceride composition has an iodine value less than 5 mg I₂/g.

Aspect 11: The blend of any of Aspects 1-10, wherein melt point temperature Y is from 37° C. to 45° C.

Aspect 12: The blend of any of Aspects 1-11, wherein melt point temperature X is from 38° C. to 42° C.

Aspect 13: The blend of any of Aspects 1-12, wherein the blend has a melt point temperature of from 32° C. to 36° C.

Aspect 14: The blend of any of Aspects 1-13, wherein the blend has an onset of crystallization temperature of from 28° C. to 36° C.

Aspect 15: The blend of any of Aspects 1-14, additionally comprising a lower melting triglyceride composition that has a melt point temperature Z that is the same as or less than melt point temperature X.

Aspect 16: The blend of Aspect 15, wherein the lower melting triglyceride composition is solid or semi-solid at 25° C.

Aspect 17: The blend of Aspect 10, wherein the lower melting triglyceride composition is liquid at 25° C.

Aspect 18: A method of compatibilizing an esterified propoxylated glycerol composition having a melt point temperature X and a lower melting triglyceride composition having a melt point temperature Z which is lower than melt point temperature X, comprising combining the esterified propoxylated glycerol composition and the lower melting triglyceride composition with a higher melting triglyceride composition having a melt point temperature Y which is greater than melt point temperature X of the esterified propoxylated glycerol composition, wherein i) crystallization of the esterified propoxylated glycerol composition, in the absence of the higher melting triglyceride composition, takes place within a temperature range A, ii) crystallization of the higher melting triglyceride composition, in the absence of the esterified propoxylated glycerol composition, takes place within a temperature range B, and iii) temperature range A and temperature range B at least partially overlap.

Aspect 19: A method of making a food product comprising an esterified propoxylated glycerol composition having a melt point temperature X and crystallizing within a temperature range A, comprising formulating the food product to include a higher melting triglyceride composition having a melt point temperature Y which is greater than the melt point temperature X of the esterified propoxylated glycerin composition and crystallizing within a temperature range B which at least partially overlaps with temperature range A.

### DETAILED DESCRIPTION OF CERTAIN EMBODIMENTS OF THE INVENTION

### Analytical Methods

Analytical methods for melt point temperature, onset of crystallization temperature and crystallization temperature range were conducted using a TA Q2000 differential scanning calorimeter (DSC) with a cooling rate of 5° C./min and a heating rate of 5° C./min. Following data collection, the resultant data sets are analyzed using TA Universal Analysis software (v4.5A).

Melt Point Temperature

In the context of the present invention, melt point temperature is measured as the peak melt temperature from the DSC heat cycle.

Crystallization Temperature Range

In the context of the present invention, crystallization temperature range is measured as the range from the onset of crystallization temperature to the return of the crystallization curve to the baseline, as generally understood.

Onset of Crystallization Temperature

In the context of the present invention, onset of crystallization temperature is measured as the intersection of the tangents of the baseline and the crystallization curve, as generally understood. The data are taken from the DSC cooling cycle.

Mettler Drop Point

In the context of the present invention, Mettler drop point is measured according to the AOCS Cc 18-80 standard.

Solid Fat Content

In the context of the present invention, solid fat content (sometimes also referred to as “solid fat index”) is measured according to the AOCS Cd16-81 standard. Solid fat index (SFI) is the integration of the area under the melt curve to assess the level of solids as a function of temperature for materials analyzed with DSC.

### Esterified Propoxylated Glycerol Compositions

The present invention may be practiced using any of the esterified propoxylated glycerol compositions known in the art. For example, the esterified propoxylated glycerol composition may be solid, semi-solid or liquid at room temperature. In preferred embodiments of the invention, however, the esterified propoxylated glycerol composition has a relatively high melt point temperature, i.e., a melt point temperature not less than normal human body temperature. For example, the melt point temperature of the esterified propoxylated glycerol composition may be at least 37° C., at least 38° C., or at least 39° C. The use of such relatively high melting esterified propoxylated glycerol compositions will help to reduce the incidence of gastrointestinal issues such as “anal leakage” when a food product containing a blend in accordance with the present invention is ingested.

Esterified propoxylated glycerols (EPGs) are structurally similar to triglycerides but contain oxypropylene structural units derived from propylene oxide between the glycerol and fatty acid chains to form “extended” glycerides. EPGs are not recognizable by lipases and fat digesting enzymes, and are passed through the digestive tract essentially intact, thus providing no or reduced calories (depending upon the degree of propoxylation).

Suitable EPGs include those synthesized to have a high melt point temperature (for example, from 37° C. to 42° C. or 37° C. to 39° C., i.e., at or somewhat above normal human body temperature of 37° C.). A single type of EPG may be used as the esterified propoxylated glycerol composition, or a combination of different EPGs may be used as the esterified propoxylated glycerol composition. The melt point temperature of the EPG composition may be, for example, at least 37.0° C., 38.0° C., 39.0° C., 40.0° C., 41.0° C., or 42.0° C. The melt point temperature of the EPG composition may be, for example, less than 55° C., 50° C., 49° C., 48° C., 47° C., 46° C., 45° C., 44° C., 43° C., 42° C., 41° C., 40° C. or 39° C.

EPG compositions may be prepared by reacting propoxylated glycerol, having for example from about 2 to about 8 oxypropylene oxide units per glycerol, with an excess of a saturated or unsaturated C8 to C24 fatty acid or mixtures thereof, at temperatures of from about 100° C. to about 250° C. Processes for making EPG compositions are disclosed, for example, in U.S. Pat. Nos. 4,983,329; 5,175,323; 5,288,884; 5,304,665; 5,362,894; 5,387,429; 5,399,728; 5,466,843; 5,589,217; 5,597,605; 5,603,978; 5,641,534; 5,645,881; 5,681,939; 5,872,269; 5,986,117; 6,002,030; 8,354,551; and 9,533,936, the disclosures of which are herein incorporated by reference in their entirety for all purposes. Examples of C8 to C24 fatty acids that may be employed include, without limitation, saturated acids, such as, caprylic acid, capric acid, lauric acid, myristic acid, palmitic acid, stearic acid, arachidic acid, behenic acid and combinations thereof. Examples of unsaturated acids that may be employed include, but are not limited to, oleic acid, linoleic acid, a-linolenic acid, arachidonic acid, eicosapentaenoic acid, erucic acid, docosahexaenoic acid, palmitoleic acid, eicosenoic acid, and combinations thereof. The fatty acids may be naturally occurring or synthetically produced. Similarly, mixtures of fatty acids may be used including those mixtures obtained by splitting natural or modified triglycerides, such as babassu oil, canola oil, cocoa butter, coconut oil, corn oil, cottonseed oil, jojoba oil, lard, meadowfoam oil, menhaden oil, olive oil, palm oil, palm kernel oil, peanut oil, rapeseed oil, rice bran oil, safflower oil, sesame seed oil, soybean oil, sunflower oil and tallow, fractions thereof, or fully or partially hydrogenated derivatives thereof as well as mixtures or fractionated mixtures thereof.

The melt point temperature of the EPG composition can be altered by the particular fatty acids used to form the EPG composition, such as is described herein, or by altering the degree of propoxylation of the glycerol, such as is described herein.

According to certain embodiments, the EPG composition may have a relatively high solid fat content at about room temperature. For example, the EPG composition used to form the inventive blend with a higher melting triglyceride may have a solid fat index at 20° C. of from 75 to 99 or from 80 to 95.

In other embodiments, however, the EPG composition may have a lower solid fat content at room temperature. For example, the EPG composition may have a solid fat content at 20° C. of from 50 to 80 or from 55 to 75.

The EPG composition may have a degree of propoxylation of at least about, or at least, 2, 2.5, 3, 3.5, 4, 4.5, 5, 5.5, 6, 6.5, 7, 7.5 or 8 and less than about, or less than, 10, 9.5, 9, 8.5, 8, 7.5, 7, 6.5 or 6. In certain embodiments, the EPG has a degree of propoxylation of about 4 to 6 or about 5.

The degree of propoxylation will influence the type(s) of fatty acid(s) that should be selected in order to achieve a particular desired melt point temperature in the EPG composition.

For example, an EPG composition having a degree of propoxylation of 3 may have, in certain embodiments, predominantly a combination of palmitic and stearic acids to achieve a melt point temperature in the range of 38-39° C. Such fatty acids are available from fully hydrogenated palm oil, or can be sourced from a broad range of edible oils, including, without limitation, soybean oil, canola oil, corn oil, coconut oil, palm kernel oil, sunflower oil, cottonseed oil, safflower oil, peanut oil and combinations thereof.

An EPG composition having a degree of propoxylation of 5 may, for example, incorporate fatty acids containing mostly saturated C16 and C18 chains, which are readily available from edible oils including soybean oil, corn oil, canola oil, sunflower oil, safflower oil, cottonseed oil and peanut oil, and a significant proportion of saturated C22 chains from high erucic acid rapeseed oil (HERO, sometimes also referred to as HEAR). Erucic fatty acid (C22:1) can be converted to behenic acid (C22:0) by conventional hydrogenation. For example, an EPG composition having a degree of propoxylation of 5 may achieve a melting point of about 38-39° C. using about 60% stearic acid (C18:0), 30% behenic acid (C22:0), 9% palmitic acid (C16:0), and 1% gadoleic acid (C20:0). These proportions of fatty acids may be obtained by blending soybean oil fatty acids (about 15% by weight) with HERO (High Erucic Rapeseed Oil) fatty acids (about 85% by weight) and fully hydrogenating them to convert unsaturated to saturated fatty acids.

To achieve an EPG composition having a degree of propoxylation of 8 and a melt point temperature of 38-39° C., esterification of a propoxylated glycerol (containing 8 moles of reacted propylene oxide per mole of glycerol) with a fatty acid mixture containing about 50% by weight behenic acid (C22:0) may be carried out, for example. HERO varieties naturally produce 35-45% erucic acid (C22:1), and fully hydrogenated HERO fatty acids may be enhanced with distilled behenic acid (C22:0) to obtain the desired melt point temperature.

The type(s) of fatty acid(s) employed to esterify a propoxylated glycerol may also be selected and controlled to vary the solid fat profile of an esterified propoxylated glycerol composition. For example, it is possible for two EPG compositions to have similar melt point temperatures and yet have very different solid fat contents at particular temperatures.

For example, an EPG composition having a melt point temperature within the range of 38 to 40° C. and useful in confectionary products as a replacement for cocoa butter and fractionated palm kernel oil may have a relatively high solid fat content (e.g., 85 to 95) at temperatures up to about 25° C., followed by a relatively sharp drop in solid fat content between about 30 to 35° C., and a solid fat content in accordance with the following profile:

95-99 at 10° C.

94-98 at 20° C.

93-97 at 25° C.

86-92 at 30° C.

49-55 at 35° C.

0-3 at 40° C.

In another example, an EPG composition also having a melt point temperature within the range of 38 to 40° C. and useful in spreadable-type food products, such as nut butters, may have a solid fat content in accordance with the following profile, wherein the EPG composition has a significant liquid content at room temperature and solid fat content more gradually decreases between room temperature and human body temperature, in accordance with the following profile:

71-78 at 10° C.

59-70 at 20° C.

43-55 at 25° C.

30-40 at 30° C.

18-28 at 35° C.

0-0.5 at 40° C.

In accordance with one aspect of the invention, an esterified propoxylated glycerol composition is prepared by esterifying a propoxylated glycerol having a degree of propoxylation of about 5 with a fatty acid composition comprising about 50 to about 70% by weight C20-C22 saturated fatty acid (e.g., arachidic acid plus behenic acid), about 20 to about 30% by weight of one or more C18 unsaturated fatty acids, and, optionally, up to about 5% by weight of one or more fatty acids other than behenic acid, C18 unsaturated fatty acids and C16-C18 saturated fatty acids. The balance of the fatty acid composition, to a total of 100% by weight, consists of one or more C16-C18 saturated fatty acids. The use of such a fatty acid composition has been found to provide an esterified propoxylated glycerol composition that is especially suitable for spreadable products such as nut butters.

### Higher Melting Triglyceride Compositions

According to various aspects of the present invention, an esterified propoxylated glycerol composition is combined with a higher melting triglyceride composition having a melt point temperature which is greater than the melt point temperature of the esterified propoxylated glycerol composition. Moreover, crystallization of the higher melting triglyceride composition, in the absence of the esterified propoxylated glycerol composition, and crystallization of the esterified propoxylated glycerol composition, in the absence of the higher melting triglyceride composition, take place within temperature ranges which at least partially overlap with each other. Such co-crystallization of the esterified propoxylated glycerin and the higher melting triglyceride composition has been found to be important in achieving the desired improvements in properties, as described elsewhere herein in more detail.

As used herein, the term “triglyceride” refers to an ester of glycerol (glycerin) in which all three hydroxyl groups of the glycerol molecule have been replaced by ester groups (typically, by fatty acid ester groups such as C8-C26 saturated and unsaturated acid groups). However, it is understood that higher melting triglyceride compositions suitable for use in the present invention may contain relatively minor amounts of compounds other than triglyceride, such as mono- and di-esters of glycerol, antioxidants, free fatty acids and other substances typically present at low levels in fats and oils derived from natural and synthetic sources. Generally speaking, however, it will be desirable for the higher melting triglyceride composition to contain at least 95%, at least 96%, at least 97%, at least 98%, at least 99% or at least 99.5% by weight triglyceride. The higher melting triglyceride composition may contain a single type of triglyceride, but more typically will contain a mixture of two or more different triglycerides.

The higher melting triglyceride composition may be a refined or purified fat or oil derived from a natural source, such as a plant or animal. Suitable higher melting triglyceride compositions may also be prepared by further processing of a naturally-derived triglyceride composition. For example, a naturally-derived triglyceride composition may be fractionated and/or fully or partially hydrogenated and/or interesterified to provide a higher melting triglyceride composition. Blends of two or more different naturally-derived triglycerides, at least one naturally-derived triglyceride and at least one further-processed (fractionated, hydrogenated and/or interesterified) naturally-derived triglyceride, or two or more different further-processed naturally-derived triglycerides, for example, can be utilized as the higher melting triglyceride composition.

Suitable higher melting triglyceride compositions may also be synthetically prepared by, for example, esterifying glycerol with one or more fatty acids.

To improve the oxidative stability of the inventive blends, it may be desirable to employ a higher melting triglyceride composition that is fully or essentially fully saturated. For example, in various embodiments of the invention the higher melting triglyceride composition may have an iodine value not greater than 10 mg I₂/gram, not greater than 5 mg I₂/gram or not greater than 1 mg I₂/gram.

Sources of triglycerides suitable for use in the higher melting triglyceride compositions of the present invention include, but are not limited to, babassu oil, canola oil, cocoa butter, coconut oil, corn oil, cottonseed oil, jojoba oil, lard, meadowfoam oil, menhaden oil, olive oil, palm oil, palm kernel oil, peanut oil, rapeseed oil, rice bran oil, safflower oil, sesame seed oil, soybean oil, sunflower oil and tallow as well as fractionated, hydrogenated and/or interesterified derivatives thereof.

Fatty acids useful in preparing synthetic triglycerides for use in the higher melting triglyceride component of the blends of the present invention include naturally-derived fatty acids (e.g., fatty acids obtained by splitting (hydrolysis) of natural fats and oils), naturally-derived and modified fatty acids (e.g., fatty acids obtained by splitting of natural fats and oils followed by modification such as fractionation and/or hydrogenation, fatty acids obtained by modification of natural fats and oils (e.g., fractionation and/or hydrogenation) followed by splitting), or fully synthetic fatty acids as well as combinations thereof.

Particular fatty acids which may be used to synthetically prepare a suitable higher melting triglyceride composition or which may be incorporated in esterified form in a naturally-derived and/or modified triglyceride used as a higher melting triglyceride composition include C8 to C26 saturated and unsaturated fatty acids such as caprylic acid, capric acid, lauric acid, myristic acid, palmitic acid, stearic acid, arachidic acid, behenic acid, oleic acid, linoleic acid, a-linolenic acid, arachidonic acid, eicosapentaenoic acid, erucic acid, docosahexaenoic acid, palmitoleic acid, eicosenoic acid, and combinations thereof.

However the higher melting triglyceride composition is prepared or obtained, it has found to be important to select a higher melting triglyceride composition which has certain characteristics relative to the characteristics of the esterified propoxylated glycerol composition which is intended for inclusion in the blend. In particular, the higher melting triglyceride composition should have a melt point temperature Y which is greater than the melt point temperature X of the esterified propoxylated glycerol composition, wherein i) crystallization of the esterified propoxylated glycerol composition, in the absence of the higher melting triglyceride composition, takes place within a temperature range A, ii) crystallization of the higher melting triglyceride composition, in the absence of the esterified propoxylated glycerol composition, takes place within a temperature range B, and iii) temperature range A and temperature range B at least partially overlap. In one desirable embodiment, the types and amounts of esterified propoxylated glycerol and higher melting triglyceride composition are selected such that the resulting blend has a melt point temperature W which is lower than melt point temperature X. This embodiment will be advantageous in applications where the esterified propoxylated glycerol composition, by itself, has a relatively high melt point temperature that would adversely affect the organoleptic or other key properties of the food product prepared therefrom. For instance, when the esterified propoxylated glycerol composition has a melt point temperature above human body temperature, it may impart a waxy mouthfeel to the food product which can be reduced or eliminated by modifying the esterified propoxylated glycerol composition with a higher melting triglyceride composition that provides (by forming a eutectic composition, for example) a blend having a melt point temperature below normal human body temperature.

In various embodiments of the invention, melt point temperature Y is not more than 12° C., not more than 11° C., not more than 10° C., not more than 9° C., not more than 8° C., not more than 7° C., not more than 6° C. or not more than 5° C. greater than melt point temperature X.

In still further embodiments of the invention, the esterified propoxylated glycerol composition has an onset of crystallization temperature I and the higher melting triglyceride composition has an onset of crystallization temperature II, wherein the onset of crystallization temperature I may be the same as the onset of crystallization temperature II, somewhat higher than the onset of crystallization temperature II, or somewhat lower than the onset of crystallization temperature II. For example, the onset of crystallization temperature II may be 2° C. above to 10° C. below, 1° C. above to 9° C. below, 0° C. to 8° C. below, 0° C. to 7° C. below, 0° C. to 6° C. below, 0° C. to 5° C. below, 0° C. to 4° C. below, or 0° C. to 3° C. below the onset of crystallization temperature I. In other embodiments, the onset of crystallization temperature II may be 0 to 5° C. above the onset of crystallization temperature I.

The melt and crystallization properties of the higher melting triglyceride composition may be modified and tailored to meet the above criteria, which will depend upon the particular esterified propoxylated glycerol component of the inventive blend and the desired target attributes of such blend, by selecting the particular fatty acid or acids incorporated into the higher melting triglyceride composition. For example, increasing the chain length of the fatty acid (or average chain length of the fatty acids) and increasing the proportion of saturated fatty acid ester groups in a triglyceride composition will generally increase the melt point temperature and onset of crystallization temperature of the triglyceride composition. Conversely, the melt point temperature and onset of crystallization temperature are generally decreased by shortening the chain length of the fatty acid (or shortening the average chain length of the fatty acids) and by increasing the proportion of unsaturated fatty acid ester groups in the triglyceride composition.

Illustrative, non-limiting examples of specific higher melting triglyceride compositions that may be useful in modifying certain particular types of esterified propoxylated glycerol compositions to provide blends in accordance with the present invention include:

A triglyceride composition prepared by interesterification of hydrogenated palm kernel oil (65% by weight), hydrogenated palm oil (26.25% by weight) and hydrogenated soybean oil (8.75% by weight) (melt point temperature=38-41° C.; onset of crystallization temperature=31-34° C.; Mettler drop point=44-47° C.).

A triglyceride composition prepared by esterifying glycerol with approximately equal weight amounts (±2%) of lauric acid, myristic acid, palmitic acid and a minor amount (<2% by weight) stearic acid (melt point temperature=41-44° C.; onset of crystallization temperature=24-28° C.; Mettler drop point=42-45° C.).

A triglyceride composition prepared by esterifying glycerol with approximately equal weight amounts (±2%) of lauric acid, myristic acid, palmitic acid and stearic acid (melt point temperature=43-46° C.; onset of crystallization temperature=30-34° C.; Mettler drop point=45-48° C.).

### Lower Melting Triglyceride Compositions

In certain embodiments of the invention, the EPG composition which is modified by the higher melting triglyceride composition is in combination with a lower melting triglyceride composition that has a melt point temperature that is the same as or less than melt point temperature of the EPG composition. In certain embodiments of the invention, the lower melting triglyceride composition is liquid at 25° C. (for example, a soybean oil, a peanut oil, a sunflower oil or a canola oil). In other embodiments, the lower melting triglyceride composition is solid or semi-solid at 25° C. (for example, a fractionated palm kernel oil or a coconut oil). According to particular aspects of the invention, an EPG composition which is solid or semi-solid at 25° C. is used in combination with a lower melting triglyceride composition which is liquid at 25° C.

In still further aspects of the invention, an EPG composition and a lower melting triglyceride composition are employed which exhibit, as a binary blend, at least some degree of phase separation (in particular, at least some degree of phase separation at normal use or storage temperatures, e.g., at 25° C. in the case of a nut butter). A higher melting triglyceride composition, as described herein, is utilized to modify such a binary blend such that the amount of phase separation is reduced or even eliminated altogether. The higher melting triglyceride composition thus can function as a compatibilizing agent to make the EPG composition and lower melting triglyceride composition more compatible with each other. Accordingly, one embodiment of the present invention provides a ternary blend of an EPG composition, a lower melting triglyceride composition and an amount of a higher melting triglyceride composition which is effective to lower the amount of phase separation between the EPG composition and the lower melting triglyceride composition which is observed in the absence of the higher melting triglyceride composition.

The type of triglyceride that can be used as the lower melting triglyceride composition is not particularly limited. As used herein, the term “triglyceride” refers to an ester of glycerol (glycerin) in which all three hydroxyl groups of the glycerol molecule have been replaced by ester groups (typically, by fatty acid ester groups such as C8-C26 saturated and unsaturated acid groups). However, it is understood that lower melting triglyceride compositions suitable for use in the present invention may contain relatively minor amounts of compounds other than triglyceride, such as mono- and di-esters of glycerol, antioxidants, free fatty acids and other substances typically present at low levels in fats and oils derived from natural and synthetic sources. Generally speaking, however, it will be desirable for the lower melting triglyceride composition to contain at least 95%, at least 96%, at least 97%, at least 98%, at least 99% or at least 99.5% by weight triglyceride. The lower melting triglyceride composition may contain a single type of triglyceride, but more typically will contain a mixture of two or more different triglycerides.

The lower melting triglyceride composition may be a refined or purified fat or oil derived from a natural source, such as a plant or animal. Suitable lower melting triglyceride compositions may also be prepared by further processing of a naturally-derived triglyceride composition. For example, a naturally-derived triglyceride composition may be fractionated and/or fully or partially hydrogenated and/or interesterified to provide a lower melting triglyceride composition. Blends of two or more different naturally-derived triglycerides, at least one naturally-derived triglyceride and at least one further-processed (fractionated, hydrogenated and/or interesterified) naturally-derived triglyceride, or two or more different further-processed naturally-derived triglycerides, for example, can be utilized as the lower melting triglyceride composition.

Suitable lower melting triglyceride compositions may also be synthetically prepared by, for example, esterifying glycerol with one or more fatty acids.

Sources of triglycerides suitable for use in the lower melting triglyceride compositions of the present invention include, but are not limited to, babassu oil, canola oil, cocoa butter, coconut oil, corn oil, cottonseed oil, jojoba oil, lard, meadowfoam oil, menhaden oil, olive oil, palm oil, palm kernel oil, peanut oil, rapeseed oil, rice bran oil, safflower oil, sesame seed oil, soybean oil, sunflower oil and tallow as well as fractionated, hydrogenated and/or interesterified derivatives thereof.

The weight ratio of EPG composition to lower melting triglyceride composition may be, for example, at least 70:30, at least 75:25, at least 80:20, at least 85:15 or at least 90:10, with greater proportions of the EPG composition being preferred where it is desired to decrease the caloric content of the blend and any food product prepared therefrom. The EPG:lower melting triglyceride composition weight ratio may be as high as 99.9:0.1, 99.5:0.5, or 99:1, for example.

### Uses for the Inventive Blends

The inventive blends described herein may be solid, semi-solid (e.g., spreadable) or liquid at 20° C. and may be formulated to provide the particular set of characteristics (including physical and organoleptic attributes) desired in an end use application.

The blends of the present invention may be used in food products, such as chocolate or chocolate-flavored products, snack bars, nutrition bars, candies, toppings, fillings, baking chips, baked goods, cookies, crackers, sweet goods, snack cakes, pies, granola bars, toaster pastries, potato chips, corn chips, tortilla chips, extruded snacks, popcorn, pretzels, potato crisps, nut spreads, dried fruit, meat snacks, pork rinds, rice cakes, corn cakes, dried vegetables, brownies, filled crackers, filled extruded snacks, enrobed extruded snacks, cheese balls, cheese curls, cheese crunches, cheese sticks, onion rings, pizza chips, potato chips, potato skins, potato sticks, veggie sticks, nougat, malted milk balls, aerated milk chocolate, ice cream and frozen yogurt (and other frozen dairy products), milk-based drinks, nut butters (e.g., peanut butter), yogurt, dips, spreads (including buttery spreads and cheese spreads), cheeses or puffed snacks. The incorporation of the EPG composition in such blends enables a significant reduction in calories, in particular calories from fat, in the formulated food product, as compared to a conventional food product having a comparable total functional fat content (i.e., containing digestible triglycerides but no EPG). By careful selection of the higher melting triglyceride composition, it is possible to provide blends which have both a relatively high content of EPG with a melting point greater than human body temperature (thus avoiding problems with “anal leakage”) and satisfactory organoleptic properties (e.g., little or no waxy mouthfeel) as a consequence of the selected higher melting triglyceride composition forming a eutectic mixture with the EPG which has a melt point temperature less than normal human body temperature.

In certain embodiments, blends of EPG compositions and higher melting triglyceride compositions are formulated to simulate the sharp melting profile of cocoa butter, making them suitable as a low-calorie cocoa butter substitute in confectionary formulations including dark and milk chocolates, chocolate candies, snack bars, toppings, fillings, baking chips and other applications in which cocoa butter is used. Such blends are advantageous, as they are capable of providing confectionary products which are easier to demold and exhibit less slump and blocking than analogous confectionary products containing the esterified propoxylated glycerol component but not the higher melting triglyceride component. That is, the incorporation of the higher melting triglyceride composition in accordance with the present invention provides an EPG-based confectionary product having attributes which more closely match those associated with conventional confectionary products containing cocoa butter. Confectionary products containing blends in accordance with the present invention may be manufactured using any suitable technique including, but not limited to, enrobing, molding/casting and panning.

As used herein, the term “chocolate” refers to all chocolate or chocolate-like compositions that contain at least one cocoa or cocoa-like component. The term is intended, for example, to include standardized and non-standardized chocolates, i.e., including chocolates with compositions conforming to the U.S. Standards Of Identity (SOI) and compositions not conforming to the U.S. Standards Of Identity, respectively, including dark chocolate, baking chocolate, milk chocolate, sweet chocolate, semi-sweet chocolate, buttermilk chocolate, skim-milk chocolate, mixed dairy product chocolate, low fat chocolate, white chocolate, non-standardized chocolates, compound chocolate and chocolate-like compositions, unless specifically identified otherwise. Furthermore, while many different countries specifically define food products containing cocoa or cocoa products as having certain ranges or ingredients, the terms chocolate, milk chocolate, and dark chocolate as used herein, do not imply, unless stated otherwise, a specific content.

Compound chocolate is a less expensive chocolate-like product and contains fats other than cocoa butter and milk or dairy fats. It is generally composed of cocoa, vegetable fat and sweeteners, with optional additives such as milk, milk fats, dairy fats, emulsifiers, flavors and colors. Compound chocolate may contain some cocoa butter that can come, for example, from partially defatted cocoa powder or from cocoa liquor, some milk fat or a combination thereof, or may be substantially free of cocoa butter, milk fat or a combination thereof. For example, compound chocolate can contain vegetable fats that are hard, solid or semi-solid at room temperature, such as coconut oil, palm oil and palm kernel oil, including fractioned palm kernel oil. Palm kernel oil, palm oil, babassu oil and coconut oils in hydrogenated, randomized or fractionated states can be used. When used in candy coating, compound chocolate may be referred to as “compound coating.” Compound coatings and compound chocolate have the additional benefit of not requiring tempering steps that may be required when using chocolate that has all, or substantially all, of its fat being cocoa butter or a combination of dairy fat and cocoa butter.

Compound chocolate can be used in milk chocolate, candy bars, coated candies, doughnut and pastry coatings, baked goods coatings, soft fillings and a variety of other applications. Compound chocolate is a lower cost alternative to real chocolate, and typically has a comparable caloric content. Replacing all or part of the vegetable fat in compound chocolate with EPG, in combination with a higher melting triglyceride composition meeting the particular criteria set forth herein, reduces caloric value while preserving other product attributes including taste, mouthfeel, melting profile, surface sheen, resistance to bloom, snap and shelf life.

As with cocoa butter, solid EPGs are capable of forming eutectic mixtures with the higher melting triglyceride compositions described herein, resulting in a blend having a melt point temperature that is less than that of the solid EPG. Such eutectic properties allow solid EPGs with melting points above human body temperature to be consumed in a blend with the higher melting triglyceride composition without the negative mouthfeel effects, like “waxy” residue in the mouth while preventing negative gastrointestinal problems such as “oil leakage”.

Eutectic blends of a solid EPG and a higher melting triglyceride composition, such as those obtained in accordance with certain aspects of the present invention, may retain a sharp melting profile useful in confectionary product applications. The sharp melting profile may include a transition from solid (>60% solid fat content) to liquid (<10% solid fat content) over a temperature range of less than about 5° C., less than about 4.5° C., less than about 4° C., less than about 3.5° C., less than about 3° C., less than about 2.5, or less than about 2° C. Accordingly, such blends can be used in confectionary and baked product applications, including as coatings, molds, dipping applications, and fillings. Due to the incorporation of the higher melting triglyceride composition (having a melt point temperature greater than that of the EPG composition and a crystallization temperature range which at least partially overlaps with the crystallization temperature range of the EPG composition), the resulting product containing such a blend can exhibit improved properties as compared to an analogous product prepared using the EPG composition but not the higher melting triglyceride composition (less slump, easier demolding, reduced blocking, and/or less bloom).

Chocolate may take the form of solid pieces of chocolate, such as bars or novelty shapes, and may also be incorporated as an ingredient of other, more complex, confections where chocolate is combined with or used to coat other foods such as caramel, peanut butter, nougat, fruit pieces, nuts, wafers, cookies, cakes, ice cream, pastries or the like.

The amount of EPG and higher melting triglyceride present in the blend suitable for use in a food product may vary, and the relative proportions of EPG and higher melting triglyceride can be manipulated to tailor the melting point and crystallization properties of the blend so that is suitable for a particular food product application. In certain embodiments, the amount of higher melting triglyceride present, by weight, is equal to or less than the amount of EPG present by weight to minimize caloric contribution. Compositions and food products may have a ratio of EPG:higher melting triglyceride by weight of from 95:5 to 50:50, 90:10 to 50:50, 85:15 to 50:50, about 95:5 to about 60:40, about 90:10 to about 60:40, 85:15 to about 60:40, about 80:20 to about 60:40, about 75:25 to about 60:40, about 70:30 to about 60:40, about 95:5 to about 70:30, 90:10 to 70:30, 85:15 to 70:30, 80:20 to 70:30, 95:5 to 75:25, 90:10 to 75:25, 85:15 to 75:25, 80:20 to 75:25, 95:5 to 80:20, 90:10 to 80:20, 85:15 to 80:20, 95:5 to 80:15, 90:10 to 80:15 or 95:5 to 90:10.

The present disclosure further provides methods of formulating a food product in which a higher melting triglyceride composition and an esterified propoxylated glycerol composition (and optionally a lower melting triglyceride composition) having the characteristics disclosed herein are added to, combined, mixed or blended with at least one food component in amounts sufficient to form a blend having a melt point temperature below 37° C., 36.5° C., 36° C., 35.5° C., 35° C., 34.5° C., 34° C., 33.5° C., 33° C., 32.5° C., or 32° C., thereby formulating the food product. The higher melting triglyceride composition and the EPG composition (and, optionally, the lower melting triglyceride composition) may be combined to form a blend prior to being added to, combined, mixed or blended with one or more other food product components, or the EPG composition and higher melting triglyceride composition (and, optionally, the lower melting triglyceride composition) may be added separately to one or more other components of the food product, and the inventive blend formed from the higher melting triglyceride composition and the EPG composition (and, optionally, the lower melting triglyceride composition) in situ with the other food product component(s).

The following non-limiting examples are purely illustrative.

### EXAMPLES

A series of experiments was carried out for the purpose of assessing the phase separation properties of blends of an esterified propoxylated glycerin (“EPG”) composition and an oil, with and without a higher melting triglyceride composition (hereafter sometimes referred to as an “XTAG”). In particular, the effect of the addition of an XTAG on the structural stability and phase separation of such blends was evaluated.

The basic layout of individual data sets is shown in Tables 1 and 2. A control sample that contains only EPG and a liquid oil was compared to a similar sample that additionally contained an XTAG. The two variables that are held constant are the caloric content (EPG) fraction in one set of samples (Table 1) and the oil fraction content in the other set of samples (Table 2). In this way, the effect of an XTAG on added stability could be analyzed.

TABLE 1
Constant Caloric Reduction

| | Wt. % | Wt. % | Wt. % | XTAG:EPG | Oil:EPG |
|---|---|---|---|---|---|
| Test | EPG | Oil | XTAG | Wt. Ratio | Wt. Ratio |
| 1 | 49.72 | 44.75 | 5.53 | 0.10 | 0.47 |
| 2 | 50 | 38.89 | 11.11 | 0.18 | 0.44 |
| 3 (Control) | 50 | 50 | 50 | 0 | 0.50 |

TABLE 2
Constant Oil

| | Wt. % | Wt. % | Wt. % | XTAG:EPG | Oil:EPG |
|---|---|---|---|---|---|
| Test | EPG | Oil | XTAG | Wt. Ratio | Wt. Ratio |
| 4 | 45 | 50 | 5 | 0.10 | 0.53 |
| 5 | 40 | 50 | 10 | 0.2 | 0.56 |

Three different EPG compositions were tested: a confectionary EPG, a saturated spreadable EPG, and an unsaturated spreadable EPG.

Two different liquid oils were tested: sunflower oil and canola oil.

The XTAG (higher melting triglyceride composition) tested was an analog of interesterified hydrogenated palm kernel oil and hydrogenated palm oil.

In order to detect phase separation in the samples, an oil fraction would need to be observed and quantified. For this purpose, a test procedure was developed in which the oil fraction is collected into a vial of known mass (G). The sample to be tested having a mass S is placed in a receiver mounted on top of the vial, with provision for any oil fraction formed in the sample to drip into the vial. The resulting assembly (vial+receiver+sample) is placed in an oven for a predetermined period of time, wherein the temperature of the oven is regulated at 25-27° C. and monitored by a thermocouple. After the predetermined period of time has lapsed (24 hr, 96 hr, 1 week), the mass of the vial (containing any oil fraction collected therein) is again measured (new vial mass=N). The phase separation (% liquid) is calculated using the following equation: (N-G)/S×100.

The test results obtained for blends of canola oil with the three different types of EPG are shown in Table 3.

TABLE 3

| | | % Liq., | % Liq., | % Liq., |
|---|---|---|---|---|
| EPG | Test | 24 hr | 96 hr | 1 week |
| Confectionary | 3 (Control) | 16.11 | 31.73 | 36.77 |
| Confectionary | 5 | 0 | 3.41 | 3.41 |
| Confectionary | 4 | 11.35 | 29.98 | 37.26 |
| Confectionary | 2 | 0 | 0 | 0 |
| Confectionary | 1 | 4.85 | 10.49 | 16.03 |
| Saturated Spreadable | 3 (Control) | 3.73 | 25.00 | 35.74 |
| Saturated Spreadable | 5 | 0 | 0 | 0 |
| Saturated Spreadable | 4 | 0 | 15.01 | 29.77 |
| Saturated Spreadable | 2 | 0 | 0 | 0 |
| Saturated Spreadable | 1 | 0 | 5.50 | 5.49 |
| Unsaturated Spreadable | 3 (Control) | 0 | 17.45 | 33.18 |
| Unsaturated Spreadable | 5 | 0 | 0 | 0 |
| Unsaturated Spreadable | 4 | 4.48 | 18.42 | 30.57 |
| Unsaturated Spreadable | 2 | 0 | 0 | 0 |
| Unsaturated Spreadable | 1 | 3.34 | 10.85 | 19.83 |

The best stability (i.e., the lowest amount of liquid fraction formed) was observed in Test 5 using an 80:20 blend of EPG:XTAG (which is a eutectic composition). A hypereutectic composition which is a 90:10 EPG:XTAG blend also provided added stability in some cases (Test 4), but phase separation did occur to some extent.

The following general conclusions can be reached based on the data obtained for the canola oil-based blends:
Without the addition of an XTAG, 50:50 blends of EPG and oil will phase separate.
Using any of the types of EPG, in order to reduce phase separation one can reduce the oil fraction and add an XTAG or reduce the EPG fraction and add the XTAG.
As seen for the hypereutectic compositions (XTAG:EPG 10:90) for each type of EPG, reducing the oil fraction and adding an XTAG provides better stability (less phase separation) than reducing the EPG fraction and adding an XTAG. However, the composition may become less spreadable (i.e., harder at room temperature).

The test results obtained for blends of sunflower oil with the three different types of EPG are shown in Table 4.

TABLE 4

| | | % Liq., | % Liq., | % Liq., |
|---|---|---|---|---|
| EPG | Test | 24 hr | 96 hr | 1 week |
| Saturated Spreadable | 3 (Control) | 5.57 | 5.74 | 11.45 |
| Saturated Spreadable | 5 | 0 | 6.64 | 6.64 |
| Saturated Spreadable | 4 | 0 | 16.93 | 22.50 |
| Saturated Spreadable | 2 | 0 | 0 | 0 |
| Saturated Spreadable | 1 | 4.65 | 18.90 | 31.29 |
| Confectionary | 3 (Control) | 13.73 | 27.89 | 33.60 |
| Confectionary | 5 | 0 | 0 | 0 |
| Confectionary | 4 | 14.57 | 33.04 | 37.80 |
| Confectionary | 2 | 0 | 0 | 0 |
| Confectionary | 1 | 10.84 | 21.71 | 26.90 |
| Unsaturated Spreadable | 3 (Control) | 0 | 12.46 | 19.14 |
| Unsaturated Spreadable | 5 | 0 | 0 | 0 |
| Unsaturated Spreadable | 4 | 0 | 16.44 | 26.43 |
| Unsaturated Spreadable | 2 | 0 | 0 | 0 |
| Unsaturated Spreadable | 1 | 0 | 9.97 | 20.18 |

Using sunflower oil, similar trends were observed as with the canola oil-containing samples of Table 3. Adding an XTAG to an EPG/oil blend at an XTAG:EPG weight ratio of 20:80 minimizes phase separation of the composition. Further, when comparing the data of Tables 3 and 4, it can be seen that the use of sunflower oil, rather than canola oil, with a confectionary EPG leads to a much lower degree of phase separation.

What is claimed is:

1. A blend comprised of an esterified propoxylated glycerol composition having a melt point temperature X and a higher melting triglyceride composition having a melt point temperature Y which is greater than the melt point temperature X of the esterified propoxylated glycerol composition, wherein i) crystallization of the esterified propoxylated glycerol composition, in the absence of the higher melting triglyceride composition, takes place within a temperature range A, ii) crystallization of the higher melting triglyceride composition, in the absence of the esterified propoxylated glycerol composition, takes place within a temperature range B, and iii) temperature range A and temperature range B at least partially overlap.

2. The blend of claim 1, wherein the blend has a melt point temperature W that is lower than melt point temperature X.

3. The blend of claim 1, wherein melt point temperature Y is not more than 12° C. greater than melt point temperature X.

4. The blend of claim 1, wherein melt point temperature Y is not more than 10° C. greater than melt point temperature X.

5. The blend of claim 1, wherein the esterified propoxylated glycerol composition has an onset of crystallization temperature I, the higher melting triglyceride composition has an onset of crystallization temperature II, and the onset of crystallization temperature II is 2° C. above to 10° C. below the onset of crystallization temperature I.

6. The blend of claim 1, wherein the esterified propoxylated glycerol composition has an onset of crystallization temperature I, the higher melting triglyceride composition has an onset of crystallization temperature II, and the onset of crystallization temperature II is 0 to 5° C. below the onset of crystallization temperature I.

7. The blend of claim 1, comprising more esterified propoxylated glycerol composition by weight than higher melting triglyceride composition.

8. The blend of claim 1, comprising 55 to 95 percent by weight of the esterified propoxylated glycerol composition and 5 to 45 percent by weight of the higher melting triglyceride composition based on the total weight of the esterified propoxylated glycerol composition and the higher melting triglyceride composition.

9. The blend of claim 1, comprising 65 to 85 percent by weight of the esterified propoxylated glycerol composition and 15 to 35 percent by weight of the higher melting triglyceride composition based on the total weight of the esterified propoxylated glycerol composition and the higher melting triglyceride composition.

10. The blend of claim 1, wherein the higher melting triglyceride composition has an iodine value less than 5 mg I₂/g.

11. The blend of claim 1, wherein melt point temperature Y is from 37° C. to 45° C.

12. The blend of claim 1, wherein melt point temperature X is from 38° C. to 42° C.

13. The blend of claim 1, wherein the blend has a melt point temperature of from 32° C. to 36° C.

14. The blend of claim 1, wherein the blend has an onset of crystallization temperature of from 28° C. to 36° C.

15. The blend of claim 1, additionally comprising a lower melting triglyceride composition that has a melt point temperature Z that is the same as or less than melt point temperature X.

16. The blend of claim 10, wherein the lower melting triglyceride composition is solid or semi-solid at 25° C.

17. The blend of claim 10, wherein the lower melting triglyceride composition is liquid at 25° C.

18. A method of compatibilizing an esterified propoxylated glycerol composition having a melt point temperature X and a lower melting triglyceride composition having a melt point temperature Z which is lower than melt point temperature X, comprising combining the esterified propoxylated glycerol composition and the lower melting triglyceride composition with a higher melting triglyceride composition having a melt point temperature Y which is greater than melt point temperature X of the esterified propoxylated glycerol composition, wherein i) crystallization of the esterified propoxylated glycerol composition, in the absence of the higher melting triglyceride composition, takes place within a temperature range A, ii) crystallization of the higher melting triglyceride composition, in the absence of the esterified propoxylated glycerol composition, takes place within a temperature range B, and iii) temperature range A and temperature range B at least partially overlap.

19. A method of making a food product comprising an esterified propoxylated glycerol composition having a melt point temperature X and crystallizing within a temperature range A, comprising formulating the food product to include a higher melting triglyceride composition having a melt point temperature Y which is greater than the melt point temperature X of the esterified propoxylated glycerin composition and crystallizing within a temperature range B which at least partially overlaps with temperature range A.
